(19) United States
(12) Patent Application Publication
(10) Pub. No.: US 2009/0000799 A1
(43) Pub. Date: Jan. 1, 2009

(54) Automatic Drop Hammer

(76) Inventor: Ottis Charles Foster, McGregor, TX (US)

Correspondence Address: OTTIS C. FOSTER, 900 WEST 6TH ST, MCGREGOR, TX, 76657, US

(21) Appl. No.: 11/770,418

(22) Filed: Jun. 28, 2007

(51) Int. Cl. B25D 11/10

(52) U.S. Cl. 173/128; 173/90

(57) ABSTRACT

A drop-hammer apparatus that can repeatedly lift and release a weighted hammer over a specified vertical distance by using a gear with teeth along less than its entire perimeter.

### BACKGROUND OF THE INVENTION

1. Field of Invention

The disclosure relates to an automated apparatus for driving tools, and more particularly to a mechanical apparatus for automatically lifting and releasing a weight to repeatedly impact a tool.

2. Background

Numerous situations exist where a tool or rigid member will need to be acted upon by repeated blows in a vertical direction. For example, steel members may need to be driven into the soil for creating a fence, to mark locations for surveying, to drill a well, or to perform soil testing. In some of these situations, the tool will need to be driven by a pre-defined force and over a pre-determined distance, such as with geo-technical testing. In other applications such as driving fence posts, all that is desired is that a force be repeatedly applied to the rigid member until the member has been driven an acceptable distance into the soil as determined by the operator.

One well known need to apply a vertical force to a rigid member involves the driving of metal fence posts into the soil. A common method for driving metal fence posts involves lifting a weighted metal sleeve vertically over the top of a metal fence post. The sleeve is fitted with handles that are attached to the outside surface of the metal sleeve. The operator then grasps these handles and repeatedly lifts against the weight of the sleeve until the sleeve has been raised vertically as high as the operator can comfortably lift. The operator then releases his lifting force and allows the sleeve to fall under the influence of gravity. Upon falling, the sleeve impacts the top of the metal fence post imparting a downward force to the metal fence post and causing it to move into the soil. The operator then repeats this motion as quickly as physically possible until the metal fence post has been driven into the soil an adequate distance.

This method of applying a vertical force to a metal fence post has several draw backs. The foremost of which is that it is extremely labor intensive. The speed at which an operator can drive fence posts is limited by the operator's strength and endurance. Additionally, the variations in downward force make it difficult to determine how far a fence post will move into the soil with each blow. This results because the force applied to the fence post during each downward motion of the weight varies by how high the operator is able to lift the weighted sleeve. Each blow will impart a different amount of downward motion to the metal fence post. This means that each fence post is driven into the soil through a trial-and-error until the fence post has been driven a satisfactory distance into the soil.

Another common need for applying a repeated vertical force to an object arises in geo-technical exploration. Often geo-technical exploration requires testing of soil characteristics by means of a standardized test. The American Society of Testing and Materials (ASTM) has adopted a standard procedure for such a soil test. This procedure, which is classified by the ASTM number D 1586, is generally known as the Standard Penetration Test (SPT). The SPT requires an operator to “[d]rive the sampler with blows from the 140-lb (63.5-kg) hammer and count the number of blows applied in each 6-in. (0.15-m) increment until” one of several scenarios occurs. The SPT further requires that “[t]he raising and dropping of the 140-lb (63.5-kg) hammer shall be accomplished using either of the following two methods: By using a trip, automatic, or semi-automatic hammer drop system which lifts the 140-lb (63.5-kg) hammer and allows it to drop 30±1.0 in. (0.76 m±25 mm) unimpeded. By using a cathead to pull a rope attached to the hammer.”

One of the more common means for conducting an SPT is using a weight attached to a rope. The rope is wrapped around a rotating cathead. An operator then applies tension to the rope causing it to tighten around the cathead and impart the cathead's rotation to the rope. The end of the rope opposite the operator is attached to the weight—commonly referred to as a “hammer”. When the operator applies tension to the rope, the tightened rope and the rotation of the cathead cause the rope to lift the hammer. When the hammer has reached a height of 30 inches above the sampler, the operator releases the tension on the rope and allows the hammer to fall onto the sampler. This process delivers one of the required blows for the SPT and is repeated until the sampler has traveled the required distance into the soil or the specified number of blows has occurred. A similar type of test is used by the Texas Department of Transportation and is referred to as the “Cone Penetrometer Test.”

There are several drawbacks to the above-described cathead system. First the falling hammer will have some resistance to its downward motion caused by the attached rope. Any tension on the rope, however slight, will exert a retarding force to the hammer. Second, the operator estimates the height of the hammer and when to release the rope. This introduces variations in drop height caused by the need for an operator to estimate the hammer's height before releasing the rope. Finally, the need for an operator to control each blow of the hammer can introduce variations into the system because of the potential for the operator to grow weary and less vigilant, the possibility of human error, and the possibility for distraction.

Alternative apparatuses for carrying out the SPT test exist. These apparatuses involve either complex chain and sprocket systems or complex hydraulic systems. The complexities of these alternatives result in a higher cost of manufacture and higher purchase prices for these automatic hammers. The complexity of these apparatuses also potentially result in increased maintenance costs and decreased reliability of the apparatuses.

The disclosed invention is advantageous in that it provides a repeated vertical force that is independent of the inconsistencies created by a human operator.

Another advantage is that it is a simple apparatus that will be inexpensive to manufacture and will be highly reliable.

A further advantage of the invention will be that it enables an operator to easily and readily change the vertical force by changing the height to which the hammer will be lifted or changing the size or shape of the hammer.

Additional advantages and novel features of the invention will be set forth in part in the description which follows, and in part will become apparent to those skilled in the art upon examination of the following or may be learned by practice of the invention. The objects and advantages of the invention may be realized and attained by means of the instrumentalities and combination particularly pointed out in the appended claims.

### SUMMARY OF THE INVENTION

An apparatus for delivering repeated vertical blows to a rigid object comprising a moving hammer that is slidably mounted within a housing that contains the hammer but permits it to move freely along a vertical path. The housing also contains a vertical opening through which a gear that is mounted to the outside of the housing can engage a toothed portion attached to or integrated into the hammer. The gear has teeth that do not cover the entire perimeter of the gear, such that only the portion with teeth will engage the hammer and the remaining portion of the gear does not contact the hammer. For example the portion that has no teeth can be sooth or removed so that the gear is comprised of only a partial circle, a kidney shape, or any other irregular shape that prevents the gear from contacting the hammer during a portion of the rotation of the gear. Then when the gear engages the hammer it lifts the hammer to a height that corresponds to the portion of the gear with teeth along the perimeter and when the gear turns such that the portion without teeth is towards the hammer, the hammer falls freely.

In accordance with one aspect of the invention, the hammer has a cylindrical shape such that its horizontal cross-section is a circle and the teeth are integral to the hammer such that the teeth are present along the entire vertical perimeter of the hammer. This allows the teeth on the gear to engage the teeth on the hammer regardless of the orientation of the hammer.

In accordance with another aspect of the invention, the teeth that are connected to the hammer lie vertically along one side of the hammer. The hammer can also be shaped such that its horizontal cross-section is a polygon such as a square, triangle, rectangle, or any other multi-sided shape. The housing is shaped such that the horizontal cross-section of its inner channel corresponds to the horizontal cross-section of the hammer. This causes the combined shape of the hammer and the housing to prevent the hammer from rotating in the housing and results in the teeth that are connected to the hammer remaining oriented toward the gear.

An additional aspect of the invention further comprises a means for rotating the gear. This rotation can be accomplished by means that are well known in the art. For example, the gear can be rotated by a crank that is turned by an operator, by a hydraulic motor, by an electric motor, an internal combustion motor, or a gear box that is powered by an external power source such as a hand crank, the mast rotary of a drilling rig, or any other rotating power source.

In accordance with another aspect of the invention, the housing is defined by an anvil attached to the lower end of the housing. A sleeve is attached to the bottom of the anvil, and the sleeve is shaped to receive a drill stem to which a sampler such as that typically used in the Standard Penetration Test defined by ASTM D 1586-67 is attached. Alternatively, the sleeve can be shaped to receive a metal fence post or any other rigid structure to which the operator wishes to apply repeated vertical blows.

The described invention thus eliminates the errors and limitations caused by relying on human judgment and power to repeatedly lift and drop the hammer because those operations are carried out mechanically. The described invention further eliminates the cost and reliability issues created by more complex devices because the elements making up the apparatus are minimized and readily available.

### BRIEF DESCRIPTION OF THE DRAWINGS

FIG. 1 is side view of one embodiment of the invention.

FIG. 2 is an additional side view of one embodiment of the invention.

FIG. 3(a) is a partial view of the invention. Some of the parts have been removed to better illustrate the gear lifting the hammer.

FIG. 3(b) is a partial view of the invention. Some of the parts have been removed to better illustrate the gear allowing the hammer to fall vertically.

FIG. 4 is a sectional view of one embodiment of the invention lying generally along the lines of section 4-4 shown in FIG. 1.

FIG. 5 is a sectional view of an additional embodiment of the invention lying generally along the lines of section 4-4 shown in FIG. 1.

FIG. 6 is a partial view of one embodiment of the invention. Some of the parts have been removed to better illustrate this embodiment of the invention.

FIG. 7 is an additional partial view of the embodiment of the invention shown in FIG. 6.

FIG. 8 is a sectional view of the embodiment of the invention shown in FIG. 6 and lying generally along the lines of section 4-4 shown in FIG. 1.

FIG. 9 is a single view of an alternative gear that can be used in an additional embodiment of the invention.

### DETAILED DESCRIPTION OF THE PREFERRED EMBODIMENT

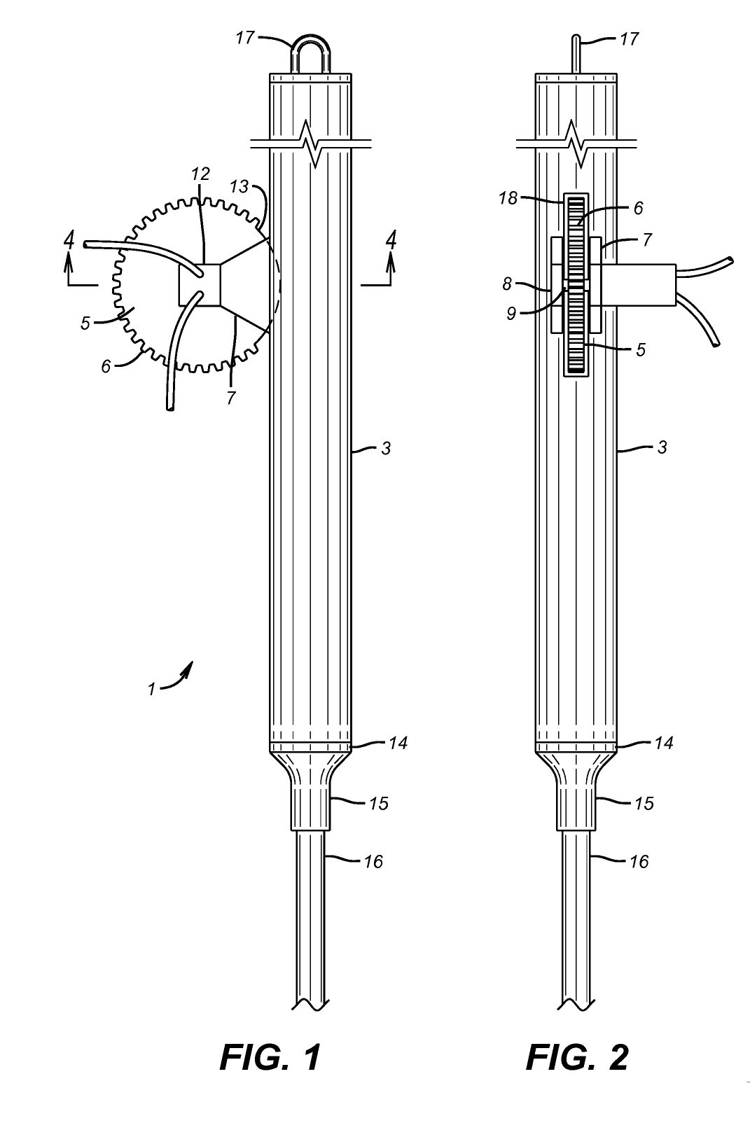

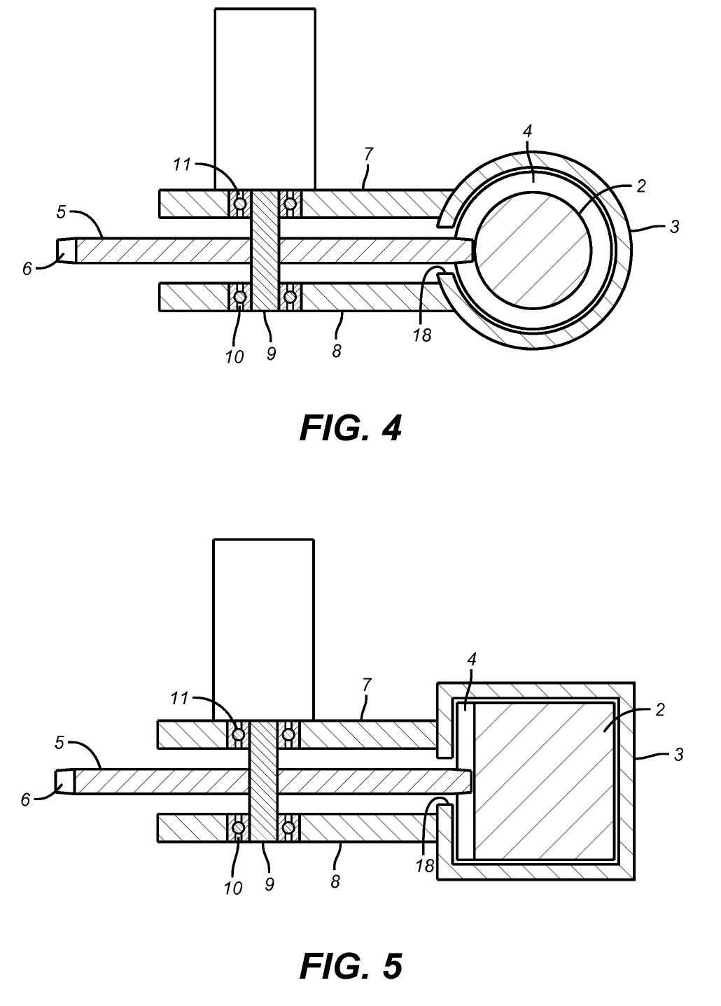

Referring now to FIGS. 1-4, reference number 1 indicates an embodiment of the automatic drop hammer system of this invention. In the illustrative embodiment shown, the hammer 2 is slidably mounted within a housing sleeve 3. The housing sleeve 3 is cylindrical and contains a vertical opening 18 along one vertical surface. The hammer 2 contains teeth 4 integral to the entire perimeter of the vertical surface of the hammer 2. Two triangular gussets 7 and 8 are attached to the outside surface of the housing sleeve 3 such that one gusset is along each of the longer horizontal sides of the vertical opening 18. The gussets 7 and 8 may be permanently affixed to the housing sleeve 3 by means such as welding or they may be removably attached to the housing sleeve 3 by means such as machine screws. A large shaft 9 passes through the gussets 7 and 8 on the end opposite the housing 3. Within each of the gussets 7 and 8, the shaft 9 is supported by bearings 10 and 11, which allow for smooth rotation of the shaft 9. A gear 5 is mounted at the midpoint of the shaft 5 between the gussets 7 and 8. The gear 5 in the embodiment shown in FIGS. 1-5 is designed such that it contains teeth 6 on less than 360 degrees of its perimeter and the remaining portion of its perimeter is smooth 13. The teeth 6 on the gear 5 are designed such that they mate with the teeth 4 on the hammer 2. The height of the gussets 7 and 8 allow the gear to be mounted so the teeth 6 on the gear 5 pass through the vertical opening 18 and mate with the teeth 4 on the hammer 2.

In one embodiment of the invention such as that which would be used with the SPT the diameter of the gear 5 is such that it has teeth along thirty (30) inches of its perimeter. Additionally for such an embodiment, the gear 5 would be rotated at a pre-determined speed and the diameter of the gear 5 would be sufficiently large to allow the hammer 2 to come to rest before being re-engaged by the gear 5. Additional embodiments of the invention would allow the gear 5 to be rotated at many different speeds with the limiting factor being the requirement that after the gear 5 releases the hammer 2, the hammer 2 must be allowed to come to rest before being re-engaged by the gear 5.

The gear 5 is fixed to the shaft 9 so that the gear 5 rotates with the shaft 9. Such attachment is accomplished by means well known in the art such as welding, machine screws, or keyways. Also attached to the shaft 9 is a hydraulic motor 12 of a type well known in the art. The hydraulic motor 12 is connected to the shaft 9 so that when the hydraulic motor 12 rotates, the shaft 9 also rotates.

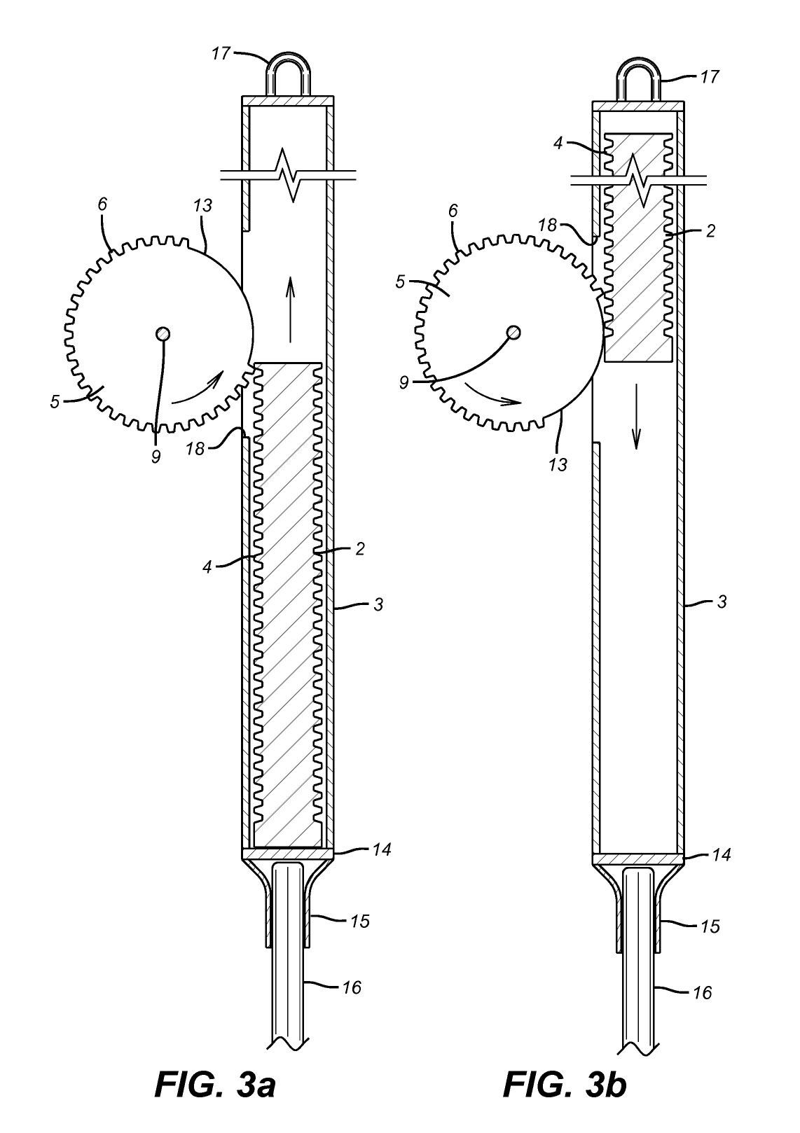

This rotation of the shaft 9 then causes the gear 5 to rotate, which in turn causes the teeth 6 on the gear 5 to engage the teeth 4 on the hammer 2. This engagement causes the hammer 2 to be moved upward as illustrated in FIG. 3a. The upward motion of the hammer 2 continues until the last of the teeth 6 on gear 5 disengage from the hammer 2 and the hammer 2 falls under its own weight. This point in the operation of this embodiment of the invention, at which the hammer 2 is released by the gear 5 is depicted in FIG. 3b.

It should be noted that regardless of the embodiment chosen, the gear 5 and where it passes through the housing 3 and mates with the teeth 4 on the hammer 2 should be protected by adequate guarding to protect an operator from pinch-points.

In the embodiment of the invention shown in FIGS. 1-3b, the gear 5 is comprised of a circular gear 5 with a portion of the perimeter having teeth 6 and a portion of the perimeter being smooth 13.

In the embodiment depicted in FIGS. 1 and 2, the apparatus 1 is further comprised of an anvil 14 and a receiving sleeve 15. The anvil 14 would typically be constructed of a metal plate of sufficient thickness, toughness, and hardness to receive repeated blows from the hammer 2 without deforming and to transmit the force of those blows to a drill-stem 16. The receiving sleeve 15 should be shaped to receive one end of the drill stem 16 and should be of sufficient length to hold the apparatus 1 in place on the drill-stem 16.

In the embodiment depicted in FIGS. 1-3b, attached to the top of the apparatus 1 is a means for lifting the apparatus, such as a lifting ring 17. Thus, the embodiment of the apparatus 1 as depicted in the Figures would be placed onto the drill-stem 16 by use of a hoist that would attach to the lifting ring 17 to raise and lower the apparatus 1 into position where it rests on the drill-stem 16. As the gear 5 rotates it will lift the hammer 2, and when the smooth portion 13 of the gear 5 reaches the hammer 2, the hammer 2 falls. As the gear 5 continues to rotate, the process repeats. In this way, the repeated lifting and dropping of the hammer 2 is accomplished. Since the apparatus 1 rests on the drill-stem 16, as the drill-stem 16 is driven into the ground, the apparatus 1 will move down with it.

In FIGS. 1 and 2, the means for rotating the shaft 9 is depicted as a hydraulic motor 12. However, several alternative means exist, such as rotating the shaft 9 by a hand-operated crank, by a gear box connected to a power source such as a mast rotary or a hand crank, by an electric motor, by an internal combustion engine, and by one of many other means that are well known in the art.

In one embodiment of the invention such as that used for the SPT, the rotation of the shaft 9 should be such that the gear 5 completes approximately forty revolutions each minute. In this situation the teeth 6 along the perimeter of the gear 5 should cover thirty inches of the perimeter so that the teeth 6 lift the hammer 2 thirty inches during each rotation. In such an embodiment, the length of the smooth portion 13 must be sufficiently large so that the hammer 2 comes to rest before being again engaged by the gear 5.

In additional embodiments of the invention, the gear 5 can be rotated at any speed. The limiting factor being that after each fall of the hammer 2, the hammer 2 must be allowed to come to rest before being re-engaged by the gear 5.

In additional embodiments of the invention, the housing 3 can be disassembled and different size gussets 7 and 8 can be installed to allow the hammer 2 and gear 5 to be changed for a hammer 2 or gear 5 of a different size. This embodiment will allow an operator to install a heavier or lighter hammer 2. This embodiment will also allow the operator to change the lift height by changing to a different sized gear 5 or a gear 5 with more or less teeth 6 along its perimeter. The operator can also vary the speed at which the gear 5 rotates to satisfy the operator's needs. These alternative embodiments will allow an operator to customize the apparatus to his or her particular application.

In another embodiment of the invention, the apparatus 1 can be attached to a piece of equipment such as a drilling rig by means of a rotating carriage. Such a carriage would allow an operator to rotate the apparatus 1 around a vertical axis and position the apparatus 1 over the drill-stem 16. Such an embodiment would eliminate the need for the lifting ring 17 and require a carriage to attach the apparatus 1 to the equipment.

In one embodiment of the invention, such as that depicted in FIGS. 1-4, the teeth 4 on the hammer 2 are cut into the entire vertical perimeter of the hammer. In such an embodiment, no matter how the hammer 2 is oriented about its vertical axis, its teeth 4 are always oriented toward the gear 5.

As depicted in FIG. 5, additional embodiments of the invention can contain a hammer 2 with a horizontal cross-section that is square. Additional embodiments of the invention could alternatively include a hammer 2 with a horizontal cross-section that is rectangular, triangular, or of any other multi-sided shape. In these alternative embodiments, the teeth 4 on the hammer 2 must be along the vertical face of the hammer 2 that faces the gear 5 and the housing 3 must have a horizontal cross-section that matches the hammer 2 and allows the hammer 2 to move freely in a vertical direction.

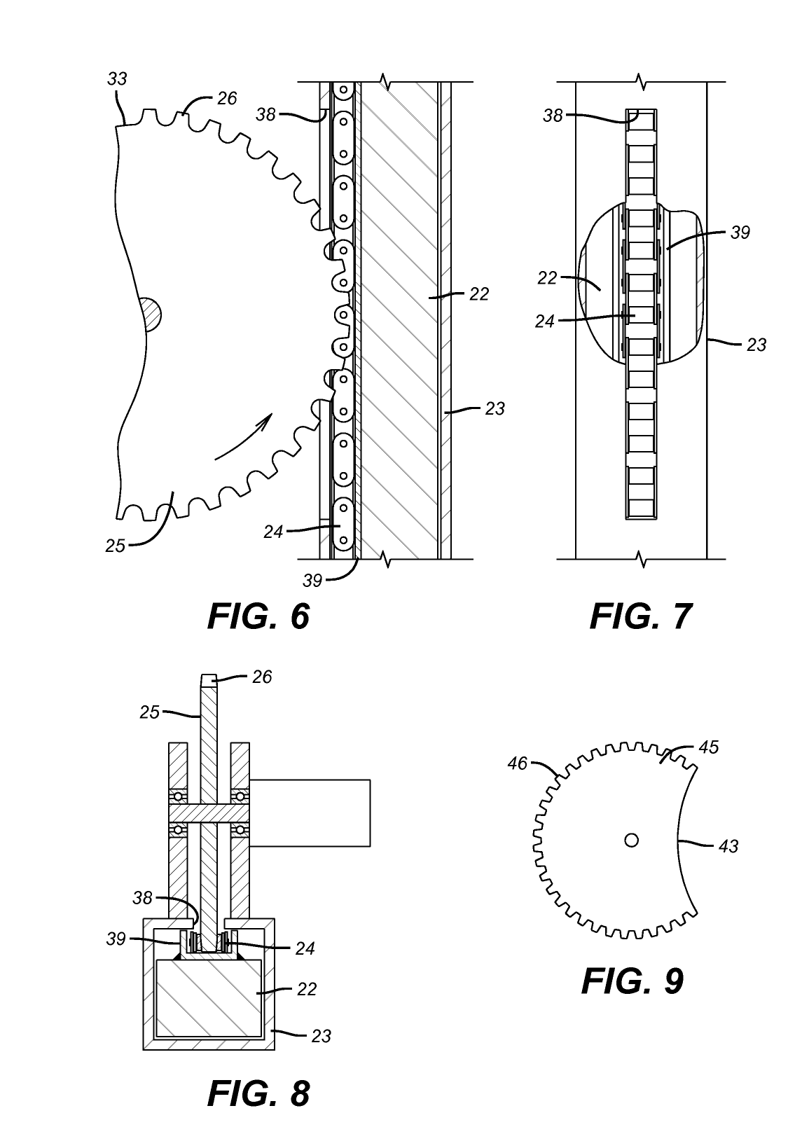

In an additional embodiment such as that shown in FIGS. 6, 7, and 8, a chain 24 is used to create the teeth on the hammer 22. The chain 24 has a pitch that corresponds to and mates with the teeth 26 on the gear 25. In the embodiment shown in FIGS. 6, 7, and 8, the chain 24 is mounted in a C-shaped channel 39 by means that are well known in the art such as welding or through the use of fasteners. The C-shaped channel 39 is then attached to the hammer 22 by means that are well known in the art such as welding the C-shaped channel 39 directly to the hammer 22 or bolting the C-shaped channel 39 directly to the hammer 22. The housing 23 of this embodiment has a horizontal cross-section that matches the horizontal cross-section of the hammer 22 with the attached chain 24 and C-shaped channel 39. This matching of the horizontal cross-sections of the housing 23 and the hammer 22 ensures that the chain 24 on the hammer 22 is always oriented toward the gear 25. Again the gear 25 has teeth 26 along a portion of its perimeter and has a portion of its perimeter that is smooth 33. The gear 25 is mounted to the housing 23, such that it passes through the vertical opening 38 and the teeth 26 mate with the chain 24. This causes the rotation of the gear 25 to impart the lifting and dropping motion to the hammer 22 as previously described. This use of a chain 24 can allow for improved mating between the gear 25 and the hammer 22.

While not illustrated in the figures, in additional embodiments of the invention the chain 24 can be replaced by a single piece of material with teeth cut into it such as a rack. This rack or the chain 24 could be mounted directly to the hammer 22 by means well-known in the art such as welding or bolting.

In another embodiment, the chain 24 or rack can be mounted in a channel that is integral to and cut into a vertical face of the hammer 22 and that is then oriented toward the gear 25.

FIG. 9 illustrates an alternative embodiment of the invention where the gear 45 has been constructed of an irregular shape. In the embodiment of the gear shown in FIG. 9, the teeth 46 lie along a circular cross-section and a concave area 43 has no teeth. The concave area 43 causes the gear to disengage from the hammer 2 when the concave area 43 is oriented towards the hammer 2. In additional embodiments of the invention, the shape of the gear 45 causes it to disengage the hammer 2 during a portion of the rotation of the gear 45. This same embodiment could be accomplished by fashioning the perimeter of the gear 45 such that the concave area 43 is straight or of an irregular shape, provided that the shape of the gear 45 causes it to disengage the hammer 2 during part of the rotation of the gear 45.

Constructing the apparatus in this manner eliminates the imprecision created by a human operator lifting the hammer. It further eliminates the imprecision and delay introduced because of fatigue that inevitably accompanies a human operator. The apparatus of the disclosed invention also uses fewer moving parts when compared to other automated drop hammers, thus simplifying the manufacture and repair of the apparatus.

I claim:

1. A drop-hammer apparatus comprising:
A cylindrical housing having a hollow, cylindrical inner cavity and further defined by a rectangular opening along one vertical side;
A cylindrical hammer with teeth around the entire vertical perimeter of the hammer slidably mated to the inner cavity of the housing; and
A gear containing teeth along less than its entire perimeter, wherein such teeth are designed to mate with the teeth of the hammer;
A means for mounting the gear to the housing such that the teeth of the gear pass through the rectangular opening along the side of the housing and mate with the teeth of the hammer; and
A means for rotating the gear.

2. The drop-hammer apparatus of claim 1 wherein:
There is an opening at the bottom end of the housing;
The drop-hammer apparatus further comprises an anvil having a top face, a bottom face, and a cross-section that matches the cross-section of the housing; and
A means for removably mounting the anvil to the opening at the bottom end of the housing; and
A hollow sleeve shaped to receive a rigid member and removably attached to the bottom face of the anvil.

3. The drop-hammer apparatus of claim 2 further comprising:
A hollow sleeve shaped to receive a rigid member; and
A means for removably mounting the hollow sleeve to the bottom face of the anvil.

4. The drop-hammer apparatus of claim 2 wherein:
The means for mounting the gear to the housing is removably attached to the housing.

5. A drop-hammer apparatus comprising:
A housing having a hollow inner cavity with a polygonal cross-section and further defined by a rectangular opening along one vertical side;
A hammer having teeth along one vertical surface and having a cross-section that slidably mates to the cross-section of the inner cavity of the housing such that the hammer cannot rotate about is vertical axis and teeth of the hammer remain oriented toward the vertical opening;
A gear containing teeth along less than three-hundred-sixty degrees of its perimeter, wherein such teeth are designed to mate with the teeth of the hammer;
A means for removably mounting the gear to the housing such that the teeth of the gear pass through the rectangular opening along the side of the housing and mate with the teeth of the hammer; and
A means for rotating the gear.

6. The drop-hammer apparatus of claim 5 wherein:
There is an opening at the bottom end of the housing;
The drop-hammer apparatus further comprises an anvil having a top face, a bottom face, and a cross-section that matches the cross-section of the housing; and
A means for removably mounting the anvil to the opening at the bottom end of the housing;
A hollow sleeve shaped to receive a rigid member;
A means for removably mounting the hollow sleeve to the bottom face of the anvil.

7. The drop-hammer apparatus of claim 5 wherein:
The means for mounting the gear to the housing is removably attached to the housing.

8. The drop-hammer apparatus of claim 5 wherein:
The teeth on the hammer are further comprised of a chain that mates with the teeth of the gear;
The drop-hammer apparatus further comprises a means for mounting the chain to the vertical face of the hammer that is oriented toward the gear.

9. The drop-hammer apparatus of claim 5 wherein:
The teeth of the hammer are integral to a rigid member and mate with the teeth of the gear; and
The drop-hammer apparatus further comprises a means for mounting the teeth to the vertical face of said hammer that is oriented toward said gear.
